(19) United States
(12) Patent Application Publication
(10) Pub. No.: US 2017/0212650 A1
(43) Pub. Date: Jul. 27, 2017

(54) DYNAMICALLY OPTIMIZING USER ENGAGEMENT

(71) Applicant: Microsoft Technology Licensing, LLC, Redmond, WA (US)

(72) Inventors: Aleksey Sinyagin, Redmond, WA (US); Anand Sengodan, Bellevue, WA (US); Khoa Chau Pham, Redmond, WA (US); Sreeram Nivarthi, Redmond, WA (US); Juan Alberto Cabello Serrano, Kirkland, WA (US)

(21) Appl. No.: 15/003,858

(22) Filed: Jan. 22, 2016

(51) Int. Cl. G06F 3/0484; G06N 99/00; G06F 17/30

(52) U.S. Cl. CPC G06F 3/0484; G06F 17/30598; G06F 17/30522; G06N 99/005

(57) ABSTRACT

The way a software program is presented to a particular user can be dynamically tailored to the user. Dynamic tailoring to the particular user can be performed in an attempt to optimize user engagement with the software. Dynamic tailoring can be based on known information about the user, available features of the software program and/or features of external disjoint software systems, a group or cluster to which the particular user is assigned, user actions (e.g., in response to behavioral influencers and/or on the state of the system operationally. The information known about the user and how he used the software previously and/or the features of the software presented to the user can be dynamically updated (changed as the system executes). Dynamic updating enables the way the software is presented to the user to change as the user is using the software. Dynamic updating can be controlled by a training subsystem.

### BACKGROUND

The more complex software is, the harder it is for a user to learn how to use the software and to learn how to use the software successfully. Learning how to use complex software is so difficult that often, classes to teach users how to use software are offered. Software trainers continue to try to find ways to make learning how to use software easier. However, it is not always feasible to conduct software training classes.

### SUMMARY

The way a software program is presented to a particular user can be dynamically tailored to the particular user. The software program that is presented to the user is typically but not always a complex and multi-purpose software program. Dynamic tailoring to the particular user can be performed in an attempt to optimize user engagement with the software. Dynamic tailoring to the particular user can be based on known information about the user. Known information about the user can include the nature of the task the user is attempting to perform (user context), the way the user used the software previously, if he did, business intelligence associated with the user, and operational intelligence associated with the user. Dynamic tailoring to a particular user can be based on available features of the software program and/or features of external disjoint software systems. The features of the software program and the features of external disjoint software systems can be determined through featurization. Dynamic tailoring to the particular user can be based on a group or cluster to which the particular user is assigned. Dynamic tailoring to the particular user can be based on user context. Dynamic tailoring to the particular user can be based on user actions (e.g., in response to behavioral influencers). Dynamic tailoring to the particular user can be based on state of the system operationally.

Dynamic tailoring to the particular user can be based on behavioral influencers associated with the features of the software. A behavioral influencer can be a piece of software that can be plugged into a system and method for dynamically optimizing user engagement as described herein. A behavioral influencer can be anything that triggers a user reaction. Behavioral influencers can be associated statistically with key performance indicators. Key performance indicators can be associated with successful use of the software. The information that is known about the user and how he used the software previously can be dynamically updated (changed as the system executes). The features of the software presented to the user can be dynamically updated. Dynamic updating enables the way the software is presented to the user to change as the user is using the software. Dynamic updating can be controlled by a training subsystem. The training subsystem can include a heuristics (stochastic, rule-based) portion and/or a learning portion.

Multiple unrelated behavioral influencers can be combined into a linked set of actions. The actions can be connected by the dynamically optimizing user engagement system to optimize core KPIs (key performance indicators) associated with successful and/or optimal use of the software. The dynamically optimizing user engagement system does not provide recommendations directly to the user but instead affects what features of the software are presented to the user and what content is included in the features (e.g., which behavioral influencers are invoked). The dynamically optimizing user engagement system can serve as a coordinator so that the application acts in such a way that the probability of a user moving from one internal cluster classification to another is maximized. That is, the dynamically optimizing user engagement system can provide engagement recommendations to an application so that the probability that the user uses the software successfully is increased.

As one example of many possible examples, guided tours can change dynamically so that each different user can have his own version of the tour, tailored to his particular interests. Instead of providing recommendations to the user (e.g., instead of saying “other users of this product also used x, y and z”), engagement recommendations as to how the user should use the product may be provided using behavior influencers, such as guided tours, email, dynamic UI (user interface) changing, etc. Influencers can be tailored in an autonomous way to each individual user to maximize the user's chance of adopting the recommended behaviors. The behavior of the system can change to adapt to the way the user previously used the system.

Disjoint systems are separate systems. For example, a system that sends marketing email is disjoint from a system that displays a project page. A system that sends marketing email is disjoint from a system that starts or directs a guided tour. A system that displays a project page is disjoint from a system that starts or directs a guided tour, and so on. Disjoint systems can be connected to create a set of behavioral influencers with each influencer contributing to the probability of a state change. A state change can mean that a user moved from one cluster to another cluster. Unlimited quantities of influencers can be added to the system as the system evolves. The end state of the user is dynamic, meaning that the definition of a KPI (e.g., a dedicated user, a paying user, etc.) can evolve as the system itself evolves and may change its definition or characteristics.

The dynamically optimizing user engagement system can automatically account for the changes (e.g., changes in influencers, changes in user interfaces, changes in the product, etc.) and can adapt its behavior to the dominant cluster feature set. The dominant cluster feature set is the set of features that are selected because they are considered the most relevant features to be to considered when determining how to customize how the application is presented to the user. Examples of features comprising the dominant cluster feature set may include, for example, the feature or features the user used when the account was created, where the account was created from, the user identifier, the authentication identification of the user, and so on. In addition, the dynamically optimizing user engagement system can connect together the influencers, the engagement subsystem and the clusters. The dynamically optimizing user engagement system can merge the OI (Operational Intelligence) and BI (Business Intelligence) systems. Real-time processing can define a set of pluggable components (called builders) and can employ extendable architecture.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings:

FIG. 1a is a block diagram comprising an overview of a dynamically optimizing user engagement system 7 in accordance with aspects of the subject matter described herein;

FIG. 1b is a block diagram 15 of a dynamically optimizing user engagement system 10 in accordance with aspects of the subject matter described herein;

FIG. 1c is an example of a method 200 for collecting profile data in accordance with aspects of the subject matter described herein;

FIG. 1d is an example of method 201 performed by a training subsystem in accordance with aspects of the subject matter described herein;

FIG. 1e is an example of a method of user interaction 202 in accordance with aspects of the subject matter described herein;

FIG. 1f is an example of a method 203 of generating engagement recommendations in accordance with aspects of the subject matter described herein;

FIG. 1g is a diagram of a cluster in N-dimensional space 56, a cluster 50 and a hierarchical grouping 63 in accordance with aspects of the subject matter described herein;

FIG. 1h illustrates an example of a method 70 of performing a clusterization algorithm in accordance with aspects of the subject matter described herein;

FIG. 2 illustrates an example of a method 204 for dynamically optimizing user engagement in accordance with aspects of the subject matter described herein;

FIG. 3 is a block diagram of an example of a computing environment in accordance with aspects of the subject matter described herein; and

FIG. 4 is a block diagram of an example of an integrated development environment in accordance with aspects of the subject matter described herein.

### DETAILED DESCRIPTION

### Overview

Single purpose software programs are created with a focus on solving a particular user need. They effectively lessen the learning curve for users by including a smaller, focused set of elements to interact with, thus increasing the likelihood of the user successfully interacting with the software. Multi-purpose, complex software programs typically provide indiscriminate access to many elements, many of which do not apply to the user's need. This presents a challenge for users who want to accomplish a particular task or who are new to the software. Accessing and interacting with many elements can represent a barrier to adoption and to successful use of the software.

Simplifying the elements in multi-purpose, complex programs and tailoring (customizing) the use or rendering of the elements based on the task and other available user information (e.g., user profile information) as described herein can maximize the opportunity for continued successful use of the program. In accordance with aspects of the subject matter described herein, multi-purpose programs can be tailored to the task and user information through the use of engagement recommendations. Engagement recommendations can be customization parameters. Engagement recommendations can be based on comparing information about the current user with information about users in the target or ideal set of users for the program. Engagement recommendations can be used to regulate any and/or all elements in a program. The functionality and content associated with the engagement recommendations can enable the user experience to be optimized for the individual user profile. In accordance with some aspects of the subject matter described herein, engagement recommendations can, for example, alter graphical user interface controls including but not limited to navigation elements or buttons. Engagement recommendations can alter grouping, sorting or state (for example, enabling or disabling a feature) for options and controls, simplifying the user's interaction with the product and maximizing user's ability to successfully complete tasks.

In accordance with some aspects of the subject matter described herein, engagement recommendations can be used to affect the type of communications, help, tips or news displayed in a user interaction in an attempt to increase a user's success with the product. Behavioral influencers can be dynamically added to the system. That is, influencers can be added to the system as the user is using the system. Because of the dynamic nature of influencers, and because the influencers can be applied to alter user actions as the system executes, traditional classification algorithms can be too slow, that is traditional classification algorithms can be insufficient in terms of learning time. Moreover, use of traditional algorithms can be too slow in terms of system performance at run time.

In accordance with aspects of the subject matter described herein, users can access and interact with a number of elements in a program. Elements in a program include but are not limited to: options and controls in a graphical interface, differentiating features, navigational elements, notifications, help contents, and so on. A differentiated feature, as used herein, refers to a feature that causes a user to be assigned to one cluster instead of to another cluster. (That is, the differentiating feature is the feature that has the largest impact on the user.) There can be multiple differentiating features. For example, the set of behavioral influencers provided to a user can be used to influence the behavior of a user in such a way that the user will be engaged with the features most likely to make him successful in his task. For example, if a user is determined to be a program manager based on the set of actions the user takes, the system can guide the user to the set of features that are most important for successful program management.

### Dynamically Optimizing User Engagement

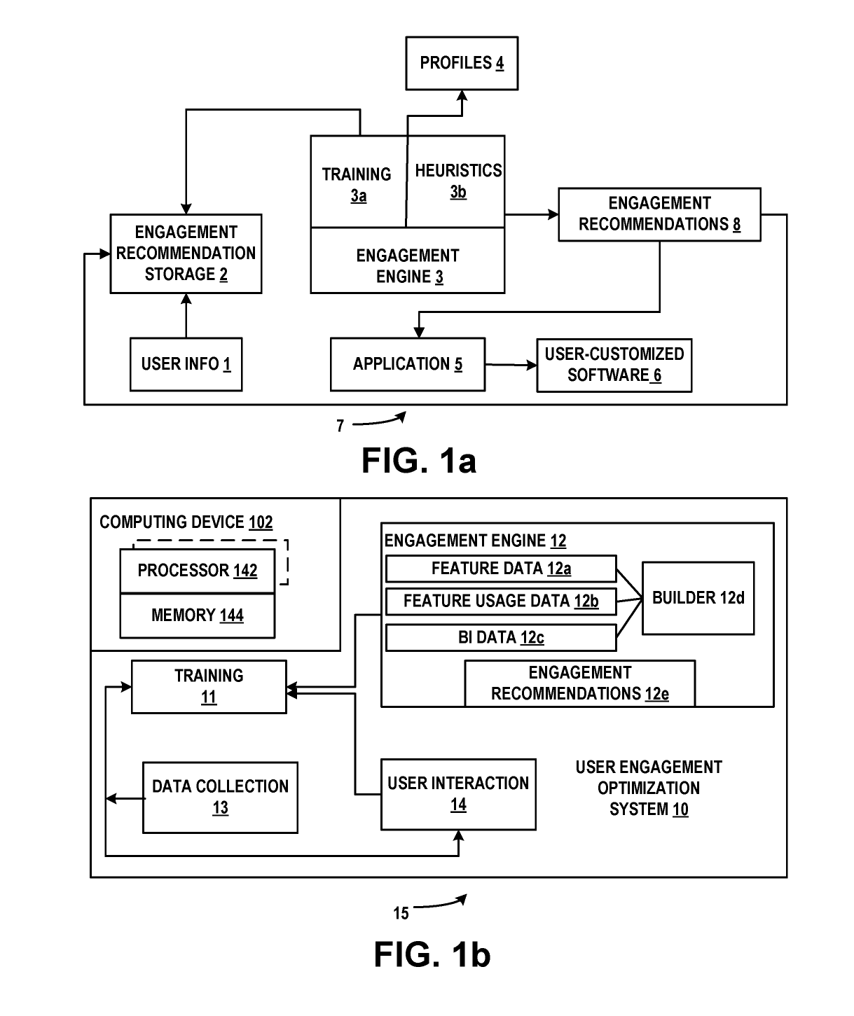

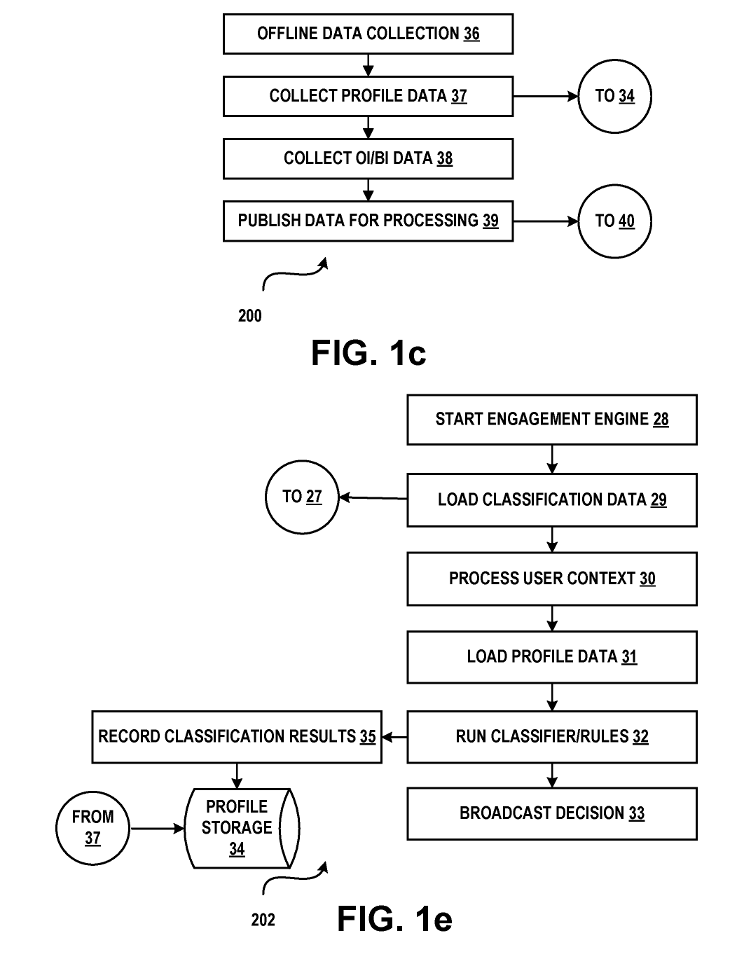

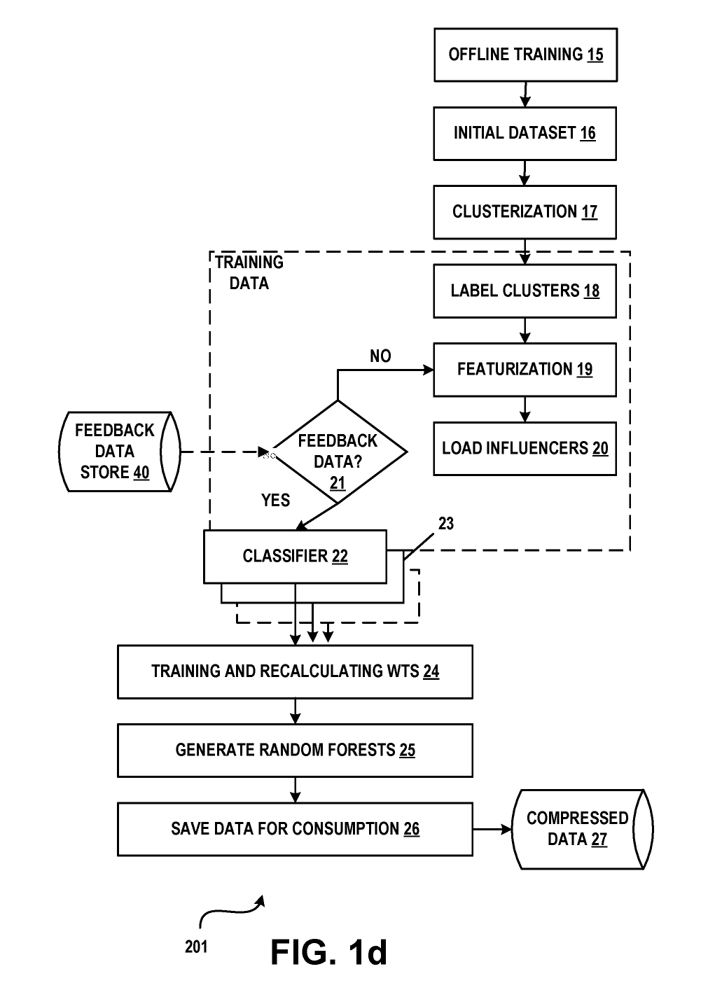

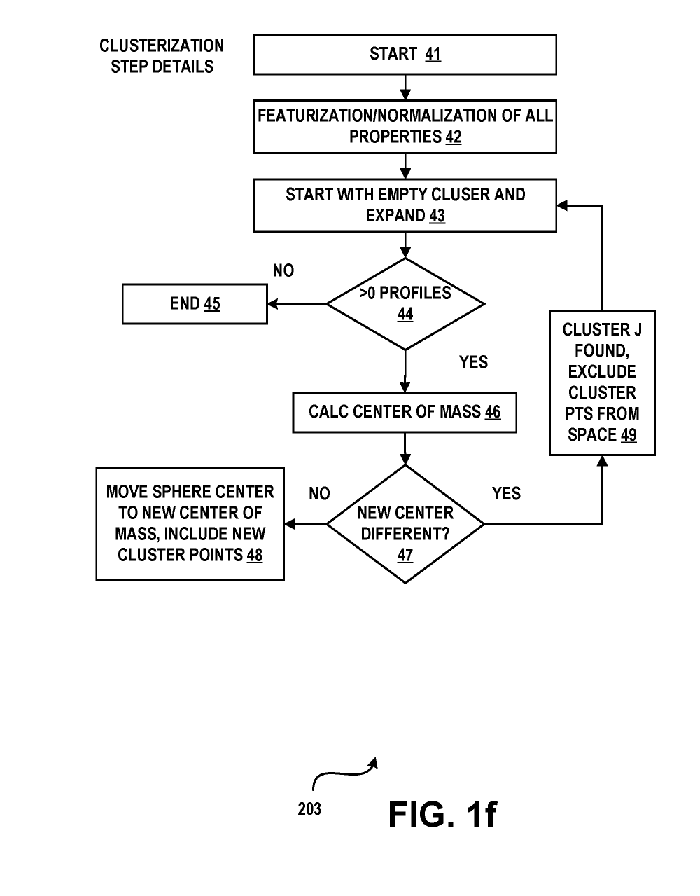

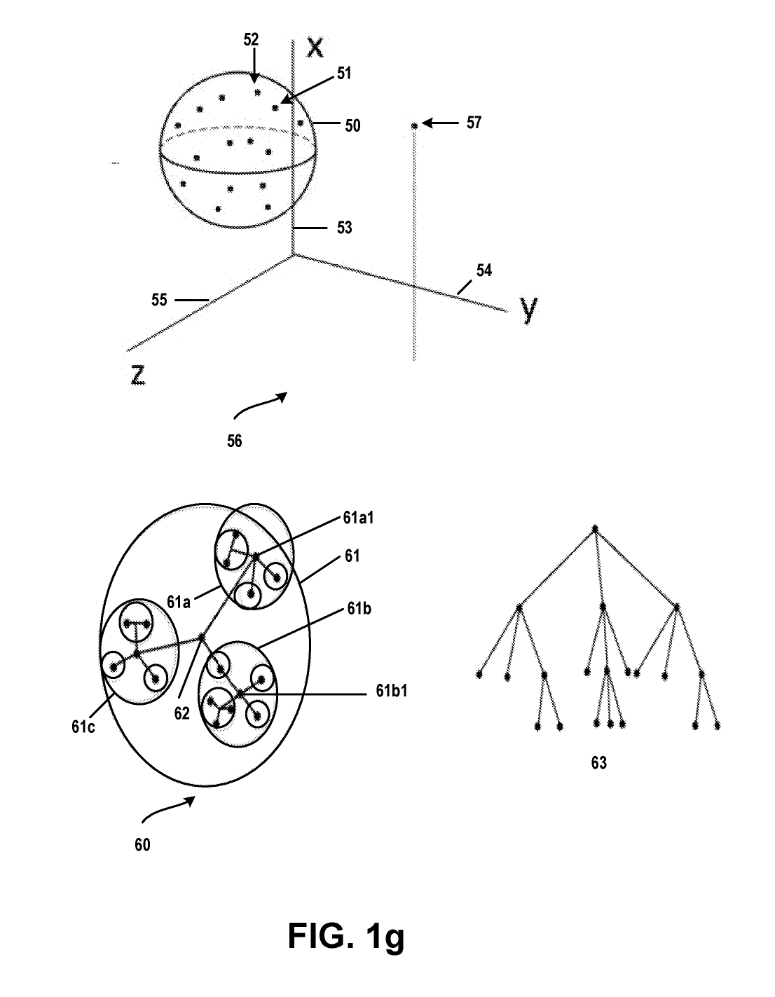

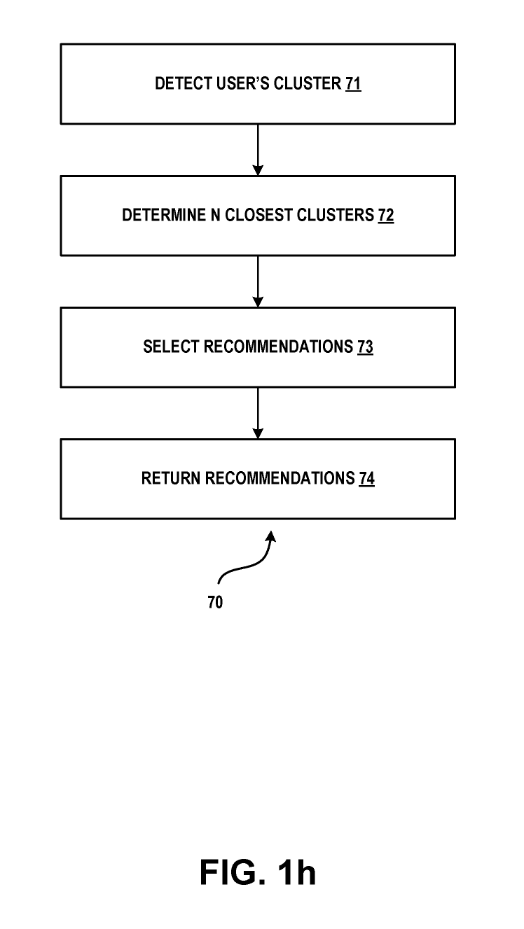

FIG. 1a illustrates a block diagram of a dynamic user engagement optimization system in accordance with aspects of the subject matter described herein. User information 1 can be provided and can be stored in engagement recommendation storage 2. User information 1 can be provided directly or indirectly by a user, can be accessed from a database or can be provided in any suitable way. All or some of the user information stored in engagement recommendation storage 2 can be provided to an engagement engine 3. An engagement engine 3 can comprise a training portion 3a and/or a heuristics portion 3b. Engagement engine 3 can augment or supplement engagement recommendations (e.g., engagement recommendation 8) stored in engagement recommendation storage 2 generated from training portion 3a and/or heuristics portion 3b. Engagement engine 3 can augment or supplement user information such as profiles 4. Engagement recommendations can be received by the engagement engine 3 and can be used by application 5 along with user information from profiles 4 to change the way application 5 appears to a user in user-customized software 6. User profile information (e.g., profiles 4) can include information about a user and usage data for the user. Usage data can include information including but not limited to a last action taken by the user and the date or date/time the last action was taken.

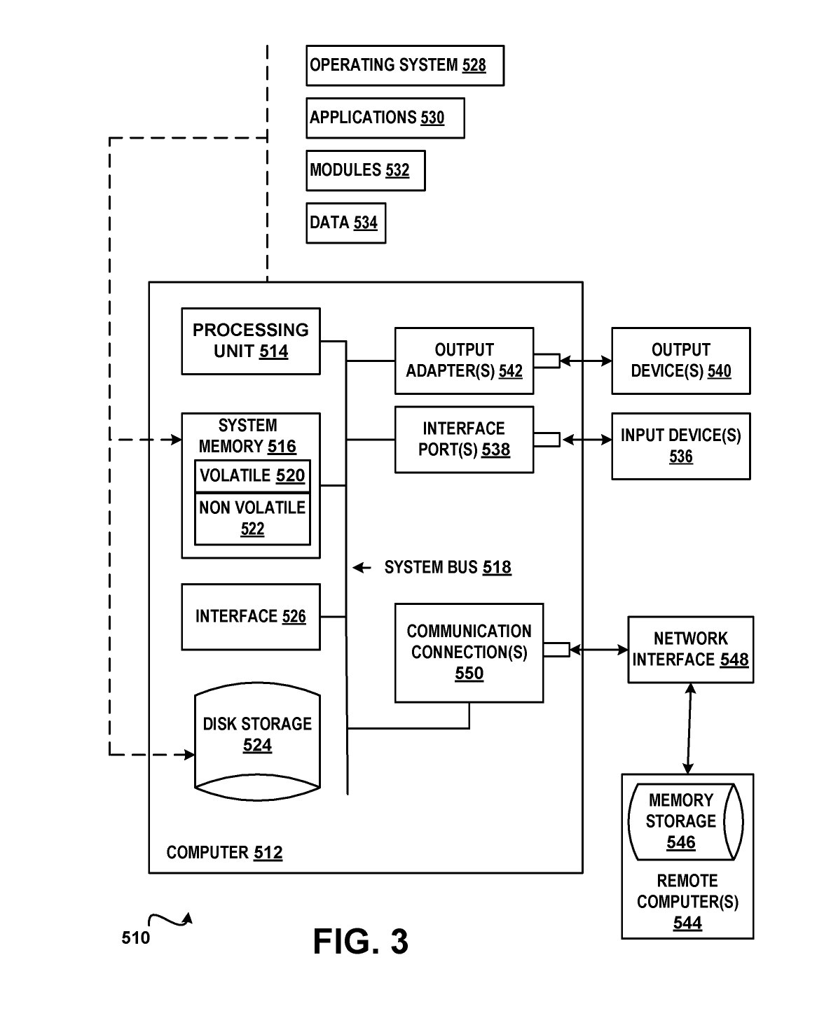

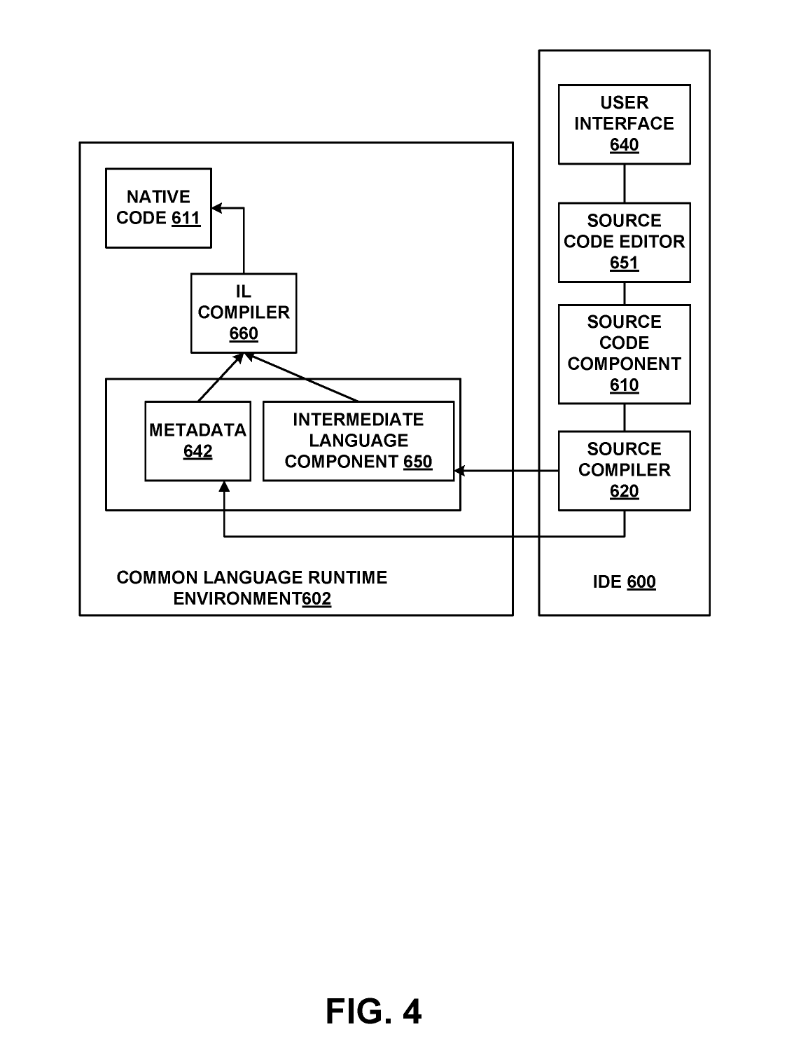

FIG. 1b illustrates another view of an example of a system 15 for dynamic user engagement optimization in accordance with aspects of the subject matter described herein. All or portions of system 15 may reside on one or more computers or computing devices such as the computers described below with respect to FIG. 3. System 15 or portions thereof may be provided as a stand-alone system or as a plug-in or add-in. System 15 or portions thereof may execute wholly or partially within an IDE or can execute wholly or partially outside an IDE. An IDE can be an IDE such as the one described with respect to FIG. 4 or can be any other IDE. All or portions of system 15 may be implemented as a plug-in or add-on.

System 15 or portions thereof may include information obtained from a service (e.g., in the cloud) or may operate in a cloud computing environment. A cloud computing environment can be an environment in which computing services are not owned but are provided on demand. For example, information may reside on multiple devices in a networked cloud and/or data can be stored on multiple devices within the cloud.

System 15 can include one or more computing devices such as, for example, computing device 102. Contemplated computing devices include but are not limited to desktop computers, tablet computers, laptop computers, notebook computers, personal digital assistants, smart phones, cellular telephones, mobile telephones, servers, virtual machines, devices including databases, firewalls and so on. A computing device such as computing device 102 can include one or more processors such as processor 142, etc., and a memory such as memory 144 that communicates with the one or more processors.

System 15 may include any one of or any combination of program modules comprising: a training subsystem such as training subsystem 11, a data collection subsystem such as data collection subsystem 13, an engagement engine or subsystem such as engagement engine 12 and/or a user interaction subsystem such as user interaction subsystem 14. Engagement engine 12 can provide engagement recommendations such as but not limited to an engagement recommendation for a layout to use for a home page, an engagement recommendation for sending or not sending marketing mail, an engagement recommendation for content to show in a feature bubble, an engagement recommendation to display or not display “quick start” instructions for the user and so on. Engagement recommendations can be generated using an engagement recommendation builder that accesses various data stores. For example, an engagement recommendation for particular input received can be generated by receiving a parameter identifying the input, and generating an engagement recommendation based on the input. One or more engagement recommendations may be returned. Engagement recommendations can be associated with a degree of confidence indicator.

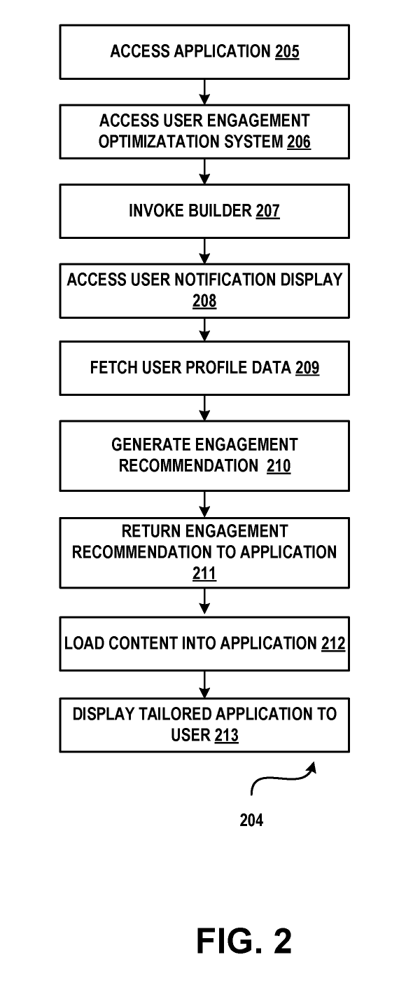

Engagement recommendation data stores can include feature-specific data, feature usage data stores, and BI data stores generated by, for example, pulling BI data at intervals. Engagement engine 12 can include one or more data stores including but not limited to: feature data 12a, feature usage data 12b, and BI data 12c, one or more engagement recommendation builders such as builder 12d and one or more engagement recommendation data stores such as engagement recommendations 12e. A builder 12d can run recommendation rules against feature data 12a, feature usage data 12b, and BI data 12c to generate one or more engagement recommendations stored in engagement recommendation data stores such as engagement recommendations data store 12e. One or more engagement recommendations can, for example, be used in a features display to determine what content to show in the display, to determine if a display will be presented in an application, to determine a type of display displayed by an application and so on. FIG. 2 below illustrates an example of a method 204 of displaying an engagement recommendation in accordance with aspects of the subject matter described herein.

FIG. 1c is an example of a method 200 of collecting profile data in accordance with aspects of the subject matter described herein. The method described in FIG. 1c can be practiced by a system or subsystem such as but not limited to the one described with respect to FIG. 1b, data collection subsystem 13. While method 200 describes a series of operations that are performed in a sequence, it is to be understood that method 200 is not limited by the order of the sequence depicted. For instance, some operations may occur in a different order than that described. In addition, one operation may occur concurrently with another operation. In some instances, not all operations described are performed. In some instances, not all operations performed are illustrated.

At operation 36 offline data collection can begin. At operation 37 profile data can be collected. Profile data can be provided in a user interaction system at operation 34 described more fully below. At operation 38 OI and Bi data can be collected. Operational intelligence (OI) is a type of business analytics that operates dynamically in real-time. Its purpose includes monitoring business activities, detecting inefficiencies, opportunities and threats and providing operational solutions. OI typically queries streaming data feeds and event data to deliver real-time analytical results as operational instructions to enable organizations to make decisions and immediately act on these analytic insights, through manual or automated actions. Business intelligence (BI) involves transforming raw data into meaningful and useful information for business analysis, to identify strategic business opportunities to provide businesses with a competitive market advantage. Historical, current and predictive views of business operations can be provided. At operation 39, the data collected can be provided to a training subsystem at operation 40. This data can be processed at operation 21, as described more fully below. Collected profile data from operation 37 can be stored at operation 34, described more fully below.

FIG. 1d is an example of a method 201 for training data in accordance with aspects of the subject matter described herein. The method described in FIG. 1d can be practiced by a system or subsystem such as but not limited to the one described with respect to FIG. 1b, training subsystem 11. While method 201 describes a series of operations that are performed in a sequence, it is to be understood that method 201 is not limited by the order of the sequence depicted. For instance, some operations may occur in a different order than that described. In addition, one operation may occur concurrently with another operation. In some instances, not all operations described are performed. In some instances, not all operations performed are illustrated.

When offline training is initiated at operation 15, training subsystem 11 can analyze existing available data. A number of features can be extracted from the analyzed data at operation 16. A feature is a quantifiable property. At operation 17 the data can be clusterized based on the extracted feature set. Clusterization is the process of grouping a set of entities into groups called clusters. Entities in the same cluster are more similar (in one or more ways) to each other than to those in another cluster. Clusterization is described more fully with respect to FIG. 1f.

At operation 18 the clusters resulting from clusterization can be judged. As used herein, “judging” refers to labeling the clusters. For example, a cluster can represent a particular type of user. Suppose for example, that in a particular cluster users generated 100 work items per second, it will be apparent that the users are not human because humans cannot work that fast. A human or a computer can thus label that cluster as a machine (or at least, as non-human) Other clusters may need to be labeled by a human. For example, the type of user represented by a cluster may need human scrutiny. Based on the type of information represented by a cluster, at operation 19 featurization and mutual exclusion can occur. Suppose a user belonging to cluster A has two properties, male and female. Suppose cluster B has both properties male and female. By mutual exclusion it can be determined that gender is not a useful feature to consider because both clusters include both genders. At operation 20 behavioral influencers can be loaded. If feedback data from feedback data store 40 is not received at operation 21, processing can return to operation 19. If feedback data is received, one or more classifiers such as classifier 22, classifier 23, etc. can be generated. Classification is the process of identifying to which of a set of clusters new data belongs. A number of different classifiers can be used. A classifier divides inputs into two or more classes, For example a spam classifier classifies messages into “spam” and “not spam”.

Classification is typically done on the basis of a training set of data comprising features which belong to a known cluster. In machine learning, classification is typically supervised learning. Supervised learning in this context refers to learning in which the clusters have been labeled or identified. The corresponding unsupervised procedure is known as clustering, and involves grouping data into categories based on some measure of inherent similarity or distance. At operation 24 training and relative weights are recalculated. At operation 25 a random forest (decision tree) can be calculated. Generation of random forests is a general method for unsupervised classification, regression and so on. A plurality of decision trees can be created at training time. The class that is the mode of the classes (classification) or mean prediction (regression) of the individual trees is output. Random decision forests correct for the tendency of the decision trees to overfit to the training set. It will be appreciated by one of skill in the art however, that other methodologies can be used. The random forest can be compiled. At operation 26 the data can be saved and at operation 27 the classifier(s) can be compressed.

FIG. 1e is an example of a method 202 of user interaction in accordance with aspects of the subject matter described herein. The method described in FIG. 1e can be practiced by a system or subsystem such as but not limited to the one described with respect to FIG. 1b, user interaction subsystem 14. While method 202 describes a series of operations that are performed in a sequence, it is to be understood that method 202 is not limited by the order of the sequence depicted. For instance, some operations may occur in a different order than that described. In addition, one operation may occur concurrently with another operation. In some instances, not all operations described are performed. In some instances, not all operations performed are illustrated.

At operation 28 the engagement engine can begin. At operation 29 classification data can be loaded into the system and the compressed classifier(s) can be run on the user context data in accordance with the input parameters at operation 30. At operation 31 the user profile data can be loaded and at operation 32 the classifier can be run. At operation 35 the classification results can be recorded. At operation 34 profile information can be updated to be used the next time this processing loop is performed at operation 31. At operation 33 the decision can be broadcast so that it can be used to determine how processing of the application proceeds.

FIG. 1f is a diagram of an example of a method for generating engagement recommendations in accordance with aspects of the subject matter described herein. The method described in FIG. 1f can be practiced by a system or subsystem such as but not limited to the one described with respect to FIG. 1b, engagement engine 12. While method 203 describes a series of operations that are performed in a sequence, it is to be understood that method 203 is not limited by the order of the sequence depicted. For instance, some operations may occur in a different order than that described. In addition, one operation may occur concurrently with another operation. In some instances, not all operations described are performed. In some instances, not all operations performed are illustrated.

At operation 41 an engagement recommendation service can begin. At operation 42 featurization and normalization of the data can begin. At operation 43, a clusterization algorithm can be applied to the data. At operation 44 if there are no more profiles to process, processing can stop at operation 45. At operation 44 if there are more profiles to process, the center of the mass can be calculated at operation 46. At operation 47 in response to determining that the calculated center of mass differs from the previous center of mass a cluster is found at operation 49, which excludes all cluster points from the space. At operation 47 in response to determining that the calculated center of mass does not differ from the previous center of mass the sphere center can be changed to the new center of mass and new inner points are included at operation 48. Processing returns to operation 46.

It will be appreciated by those of skill in the art that the term “cluster analysis” does not refer to application of a particular algorithm to data, but to the general task to be solved. Various algorithms that differ significantly in determining how a cluster is defined and how to go about the grouping process can be applied. For example, a cluster can be defined as a group having small distances between the cluster members, or as a dense area of the data space, etc. Clustering can be performed for multiple objectives. The appropriate clustering algorithm and parameter settings (including values such as the distance function to use, a density threshold or the number of clusters) depend on the individual data set and intended use of the results. Thus cluster analysis involves trial and error.

FIG. 1g includes a diagram 56 of an example of a cluster in 3-dimensional space. A cluster such as cluster 50 can be generated by the engagement engine described above. Each user can be represented as a point in N-dimensional feature space where profile properties serve as coordinates in the N-dimensional feature space. User data such as user profiles in a system can include user supplied data. User data such as user profiles in a system can include user data generated by the recommendation system. In FIG. 1g, a first user can be represented by point 51, a second user by point 52 and so on. In FIG. 1g, N-dimensional space is represented by axis x 53, y 54 and z 55. Point 57 represents a user that in not in cluster 50. User data can be viewed as a set of M vectors P={pᵢ . . . pₘ}. Standard unsupervised classifications algorithms can be applied to the set of M vectors to solve data clustering problems by partitioning P into k disjoint sets Pⱼ such as that

P=∪ⱼ₌₁^{k}Pⱼ, where k≦m and Pⱼ∩Pᵢ=0,j≠i

Unsupervised methods are mainly defined by three factors, the sample sizes, the need to support change of patterns over time and the need to auto detect unobvious but significant feature sets.

Diagram 60 of FIG. 1g represents an example of clusterization. In diagram 60 a taxon or cluster 61 includes 3 clusters comprising cluster 61a, cluster 61b and cluster 61c having a center point 62. Cluster 61a includes 5 points with a center point 61a1 and so on. Cluster 61b includes 7 points with center point 61b1 and so on. Cluster 61 can be represented as the hierarchical grouping 63. The FOREL family of algorithms is well suited to generating a solution in this problem space because this family of algorithms produces a cluster or taxon 61 of a spherical shape where the similarity is defined by distance in the defined feature space. The clusterization allows the future definition of the solution algorithm. The usage of FOREL can also allow generation of a hierarchical grouping of taxon clusters. BIGFOR or other modifications of FOREL are also suitable.

The representation above allows a solution to be implemented where the solution is based on the premise that for any user pⱼ with a known set of features, there is a set of influencers which can be applied to pᵢ to maximize the probability of pᵢ moving close to the optimal cluster Pₒₚₜ such that:

∀pᵢ:pᵢ∉Pₒₚₜ∃Pₖ:d(pᵢ,Pₒₚₜ)>d(Pₖ,Pₒₚₜ),{r₁ . . . rₙ}:max(P(pᵢ∈Pₖ|{r₁ . . . rₙ}))

Where d(a,b) represents the relative distance between points a and b. The distance d can be calculated, for example, as Euclidean distance in n-space, as follows:

$$d ( a , b ) = \sqrt{{\sum }_{i = 1}^{n} {( {a}_{i} - {b}_{i} )}^{2}}$$

The solution, however is not limited to Euclidean distance and for example Chebyshev distance, Manhattan distance or others can also be used.

The graph can be constructed to represent possible moves between clusters. The edges of the graph would represent potential moves between clusters and the weights would correspond to the conditional probability of moving between such clusters. That representation allows the design of a self-learning system which would enable any user (entity) in the system to propose a number of optimum recommendations to achieve a predefined goal state. The goal state for example, can be dedicated users, paid user or other designations. The probability function P is calculated by historical learning. Stochastic components can be applied to avoid being stuck in a local optimum instead of a global optimum. For example, the Metropolis approach can be used to introduce an acceptance ratio in addition to the defined recommendation priority. As such, profiles can be moved further away from the optimal cluster in order to reevaluate other paths to the optimum solution.

At run time for the given user pᵢ, and set of engagement recommendations {rᵢ . . . rₙ} the following four stage algorithm can be applied, as illustrated in FIG. 1h, method 70 in accordance with some aspects of the subject matter described herein. The method described in FIG. 1h can be practiced by a system or subsystem such as but not limited to the one described with respect to FIG. 1b, engagement engine 12. While method 70 describes a series of operations that are performed in a sequence, it is to be understood that method 70 is not limited by the order of the sequence depicted. For instance, some operations may occur in a different order than that described. In addition, one operation may occur concurrently with another operation. In some instances, not all operations described are performed. In some instances, not all operations performed are illustrated.

At operation 71, the user's pᵢ cluster can be detected. At operation 72 the N closest clusters to pᵢ can be determined. Based on the map of distances describing the distance from each cluster to the target, the target cluster can be chosen. If no data is available, a random cluster can be chosen. Based on the calculation of the acceptance ratio, the selected cluster can be accepted or rejected. If a cluster is rejected another cluster can be selected and the selection process can be repeated. When a cluster is selected, at operation 73, from the set of engagement recommendation's {r₁ . . . rₙ} select rₖ with probability P(pᵢ ∈Pₖ|rₖ). If rₖ is selected, eliminate all engagement recommendations from selection set not compatible with rₖ. This process can be repeated until the desired m candidates are selected. At operation 74, the engagement recommendations can be returned to the user. The feedback data can be recorded. The probabilities can be updated.

The engagement engine can dynamically learn optimal steps and can utilize a combination of heuristics and stochastic methods to provide engagement recommendations based on the set of available options. It will be appreciated that practically, while, for example, a new user might not have work items or code, based on what is learned from previous runs, the system may know that the probability of a user who checks in code being a higher contributor to the conversation rate than for new users arriving from a instructional web page, the system can estimate the probability of the conversion and choose an optimal set of recommendations.

FIG. 2 illustrates an example of a method 204 for dynamically optimizing user engagement in accordance with aspects of the subject matter described herein. The method described in FIG. 1f can be practiced by a dynamic user engagement system such as but not limited to the one described with respect to FIGS. 1a-1h. While method 204 describes a series of operations that are performed in a sequence, it is to be understood that method 204 is not limited by the order of the sequence depicted. For instance, some operations may occur in a different order than that described. In addition, one operation may occur concurrently with another operation. In some instances, not all operations described are performed. In some instances, not all operations performed are illustrated.

At operation 205 the application to be tailored can be accessed. For example, the application may be accessed by a browser running on a client machine. Alternatively, the application may be accessed in any suitable way. At operation 206 an engagement engine can be accessed to get a feature recommendation. At operation 207 a builder can be invoked to generate an engagement recommendation. At operation 208 a user notification display can be accessed and data for the content of the notification can be obtained. At operation 209 user profile data can be fetched and data from the user profile such as but not limited to last action taken and date or date/time of last action taken can be returned to the builder. At operation 210 an engagement recommendation can be returned to the engagement system. At operation 211 an engagement recommendation can be returned to the application. At operation 212 content can be loaded into the notification. At operation 213 the notification can be sent or can be provided on a display (e.g., to a user), enabling the application that the user interacts with to be tailored to that particular user.

### Example of a Suitable Computing Environment

In order to provide context for various aspects of the subject matter disclosed herein, FIG. 3 and the following discussion are intended to provide a brief general description of a suitable computing environment 510 in which various embodiments of the subject matter disclosed herein may be implemented. While the subject matter disclosed herein is described in the general context of computer-executable instructions, such as program modules, executed by one or more computers or other computing devices, those skilled in the art will recognize that portions of the subject matter disclosed herein can also be implemented in combination with other program modules and/or a combination of hardware and software. Generally, program modules include routines, programs, objects, physical artifacts, data structures, etc. that perform particular tasks or implement particular data types. Typically, the functionality of the program modules may be combined or distributed as desired in various embodiments. The computing environment 510 is only one example of a suitable operating environment and is not intended to limit the scope of use or functionality of the subject matter disclosed herein.

With reference to FIG. 3, a computing device in the form of a computer 512 is described. Computer 512 may include at least one processing unit 514, a system memory 516, and a system bus 518. The at least one processing unit 514 can execute instructions that are stored in a memory such as but not limited to system memory 516. The processing unit 514 can be any of various available processors. For example, the processing unit 514 can be a graphics processing unit (GPU). The instructions can be instructions for implementing functionality carried out by one or more components or modules discussed above or instructions for implementing one or more of the methods described above. Dual microprocessors and other multiprocessor architectures also can be employed as the processing unit 514. The computer 512 may be used in a system that supports rendering graphics on a display screen. In another example, at least a portion of the computing device can be used in a system that comprises a graphical processing unit. The system memory 516 may include volatile memory 520 and nonvolatile memory 522. Nonvolatile memory 522 can include read only memory (ROM), programmable ROM (PROM), electrically programmable ROM (EPROM) or flash memory. Volatile memory 520 may include random access memory (RAM) which may act as external cache memory. The system bus 518 couples system physical artifacts including the system memory 516 to the processing unit 514. The system bus 518 can be any of several types including a memory bus, memory controller, peripheral bus, external bus, or local bus and may use any variety of available bus architectures. Computer 512 may include a data store accessible by the processing unit 514 by way of the system bus 518. The data store may include executable instructions, 3D models, materials, textures and so on for graphics rendering.

Computer 512 typically includes a variety of computer readable media such as volatile and nonvolatile media, removable and non-removable media. Computer readable media may be implemented in any method or technology for storage of information such as computer readable instructions, data structures, program modules or other data. Computer readable media include computer-readable storage media (also referred to as computer storage media) and communications media. Computer storage media includes physical (tangible) media, such as but not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices that can store the desired data and which can be accessed by computer 512. Communications media include media such as, but not limited to, communications signals, modulated carrier waves or any other intangible media which can be used to communicate the desired information and which can be accessed by computer 512.

It will be appreciated that FIG. 3 describes software that can act as an intermediary between users and computer resources. This software may include an operating system 528 which can be stored on disk storage 524, and which can allocate resources of the computer 512. Disk storage 524 may be a hard disk drive connected to the system bus 518 through a non-removable memory interface such as interface 526. System applications 530 take advantage of the management of resources by operating system 528 through program modules 532 and program data 534 stored either in system memory 516 or on disk storage 524. It will be appreciated that computers can be implemented with various operating systems or combinations of operating systems.

A user can enter commands or information into the computer 512 through an input device(s) 536. Input devices 536 include but are not limited to a pointing device such as a mouse, trackball, stylus, touch pad, keyboard, microphone, voice recognition and gesture recognition systems and the like. These and other input devices connect to the processing unit 514 through the system bus 518 via interface port(s) 538. An interface port(s) 538 may represent a serial port, parallel port, universal serial bus (USB) and the like. Output devices(s) 540 may use the same type of ports as do the input devices. Output adapter 542 is provided to illustrate that there are some output devices 540 like monitors, speakers and printers that require particular adapters. Output adapters 542 include but are not limited to video and sound cards that provide a connection between the output device 540 and the system bus 518. Other devices and/or systems or devices such as remote computer(s) 544 may provide both input and output capabilities.

Computer 512 can operate in a networked environment using logical connections to one or more remote computers, such as a remote computer(s) 544. The remote computer 544 can be a personal computer, a server, a router, a network PC, a peer device or other common network node, and typically includes many or all of the elements described above relative to the computer 512, although only a memory storage device 546 has been illustrated in FIG. 3. Remote computer(s) 544 can be logically connected via communication connection(s) 550. Network interface 548 encompasses communication networks such as local area networks (LANs) and wide area networks (WANs) but may also include other networks. Communication connection(s) 550 refers to the hardware/software employed to connect the network interface 548 to the bus 518. Communication connection(s) 550 may be internal to or external to computer 512 and include internal and external technologies such as modems (telephone, cable, DSL and wireless) and ISDN adapters, Ethernet cards and so on.

It will be appreciated that the network connections shown are examples only and other means of establishing a communications link between the computers may be used. One of ordinary skill in the art can appreciate that a computer 512 or other client device can be deployed as part of a computer network. In this regard, the subject matter disclosed herein may pertain to any computer system having any number of memory or storage units, and any number of applications and processes occurring across any number of storage units or volumes. Aspects of the subject matter disclosed herein may apply to an environment with server computers and client computers deployed in a network environment, having remote or local storage. Aspects of the subject matter disclosed herein may also apply to a standalone computing device, having programming language functionality, interpretation and execution capabilities.

The various techniques described herein may be implemented in connection with hardware or software or, where appropriate, with a combination of both. Thus, the methods and apparatus described herein, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing aspects of the subject matter disclosed herein. As used herein, the term “machine-readable medium” shall be taken to exclude any mechanism that provides (i.e., stores and/or transmits) any form of propagated signals. In the case of program code execution on programmable computers, the computing device will generally include a processor, a storage medium readable by the processor (including volatile and non-volatile memory and/or storage elements), at least one input device, and at least one output device. One or more programs that may utilize the creation and/or implementation of domain-specific programming models aspects, e.g., through the use of a data processing API or the like, may be implemented in a high level procedural or object oriented programming language to communicate with a computer system. However, the program(s) can be implemented in assembly or machine language, if desired. In any case, the language may be a compiled or interpreted language, and combined with hardware implementations.

FIG. 4 illustrates an integrated development environment (IDE) 600 and Common Language Runtime Environment 602. An IDE 600 may allow a user (e.g., developer, programmer, designer, coder, etc.) to design, code, compile, test, run, edit, debug or build a program, set of programs, web sites, web applications, and web services in a computer system. Software programs can include source code (component 610), created in one or more source code languages (e.g., Visual Basic, Visual J#, C++. C#, J#, Java Script, APL, COBOL, Pascal, Eiffel, Haskell, ML, Oberon, Perl, Python, Scheme, Smalltalk and the like). The IDE 600 may provide a native code development environment or may provide a managed code development that runs on a virtual machine or may provide a combination thereof. The IDE 600 may provide a managed code development environment using the .NET framework. An intermediate language component 650 may be created from the source code component 610 and the native code component 611 using a language specific source compiler 620 and the native code component 611 (e.g., machine executable instructions) is created from the intermediate language component 650 using the intermediate language compiler 660 (e.g. just-in-time (JIT) compiler), when the application is executed. That is, when an IL application is executed, it is compiled while being executed into the appropriate machine language for the platform it is being executed on, thereby making code portable across several platforms. Alternatively, in other embodiments, programs may be compiled to native code machine language (not shown) appropriate for its intended platform.

A user can create and/or edit the source code component according to known software programming techniques and the specific logical and syntactical rules associated with a particular source language via a user interface 640 and a source code editor 651 in the IDE 600. Thereafter, the source code component 610 can be compiled via a source compiler 620, whereby an intermediate language representation of the program may be created, such as assembly 630. The assembly 630 may comprise the intermediate language component 650 and metadata 642. Application designs may be able to be validated before deployment.

The various techniques described herein may be implemented in connection with hardware or software or, where appropriate, with a combination of both. Thus, the methods and apparatus described herein, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing aspects of the subject matter disclosed herein. As used herein, the term “machine-readable medium” shall be taken to exclude any mechanism that provides (i.e., stores and/or transmits) any form of propagated signals. In the case of program code execution on programmable computers, the computing device will generally include a processor, a storage medium readable by the processor (including volatile and non-volatile memory and/or storage elements), at least one input device, and at least one output device. One or more programs that may utilize the creation and/or implementation of domain-specific programming models aspects, e.g., through the use of a data processing API or the like, may be implemented in a high level procedural or object oriented programming language to communicate with a computer system. However, the program(s) can be implemented in assembly or machine language, if desired. In any case, the language may be a compiled or interpreted language, and combined with hardware implementations.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A computing device comprising:
at least one processor:
a memory connected to the at least one processor; and
at least one program module comprising a dynamic user engagement optimization system that when loaded into the memory causes the at least one processor to:
tailor rendering of elements in a multi-purpose software program to a particular user by dynamically generating at least one engagement recommendation, the at least one engagement recommendation generated by an engagement engine, wherein the at least one engagement recommendation controls rendering to the particular user of at least one element of a plurality of elements, wherein at least one of the plurality of elements belongs to a disjoint software system.

2. The computing device of claim 1, further comprising:
at least one program module comprising a user interaction subsystem, the user interaction subsystem comprising at least one program module that:
starts the engagement engine,
loads classification data,
processes user context,
loads user profile data,
runs a training subsystem; and
sends at least one engagement recommendation to the multi-purpose software program.

3. The computing device of claim 1, further comprising:
at least one program module comprising an off-line learning module that:
performs featurization comprising extracting software features from disjoint software programs,
performs clusterization of data into at least one cluster wherein the at least one cluster comprises a collection of data sharing a set of characteristics associated with a key performance indicator,
loads behavioral influencers comprising a software component that renders the extracted features in a user interface; and
processes feedback from user interaction with the behavioral influencers.

4. The computing device of claim 1, further comprising an off-line data collection module that:
collects user profile data,
collects operational intelligence information,
collects business intelligence information; and
sends it to an offline learning module for reclassification.

5. The computing device of claim 1, further comprising at least one program module comprising an engagement engine that:
normalizes software featurization results in real time; and
generates at least one engagement recommendation.

6. The computing device of claim 1, further comprising at least one program module comprising an engagement engine combining stochastic and heuristic rules.

7. The computing device of claim 1, further comprising at least one program module comprising an engagement engine comprising a training subsystem.

8. A method of dynamically optimizing user engagement with multi-purpose software comprising:
receiving by a processor of a computing device a request to access a multi-purpose software program, and
tailoring the multi-purpose software program to a particular user using a combination of unsupervised and supervised training.

9. The method of claim 8, further comprising:
accessing a user engagement optimization system,
invoking a builder,
accessing a user notification display,
fetching user profile data,
generating an engagement recommendation,
returning the engagement recommendation to the multi-purpose software program,
loading content into a user interface; and
displaying the user interface to a user.

10. The method of claim 8, further comprising:
dynamically tailoring the multi-purpose software program to the particular user.

11. A computing device comprising:
at least one processor:
a memory connected to the at least one processor; and
at least one program module comprising a dynamic user engagement optimization system that when loaded into the memory causes the at least one processor to:
tailor a multi-purpose software program to a particular user by generating at least one engagement recommendation that controls rendering to the particular user of at least one feature of a plurality of features of the multi-purpose software program.

12. The computing device of claim 11, wherein the at least one engagement recommendation comprises at least one customization parameter.

13. The computing device of claim 11, wherein the at least one engagement recommendation is based on a comparison of information about the particular user with information about users in a target set of users.

14. The computing device of claim 11, wherein the at least one engagement recommendation controls presentation to the particular user of at least one feature of disjoint software programs.

15. The computing device of claim 11, wherein the at least one engagement recommendation tailors functionality and content of at least one feature to the particular user.

16. The computing device of claim 11, wherein the at least one feature comprises a graphical user interface control comprising a navigation element.

17. The computing device of claim 11, wherein the at least one engagement recommendation controls grouping, sorting or state for an option or a control.

18. The computing device of claim 11, wherein the generation of the at least one engagement recommendation is based on information associated with previous usage of the multi-purpose software program by the particular user.

19. The computing device of claim 11, wherein the generation of the at least one engagement recommendation is based on business intelligence and operational intelligence associated with the particular user.

20. The computing device of claim 11, wherein the generation of the at least one engagement recommendation is based on available features of the software program, wherein behavioral influencers associated with the features of the software.
